(19) United States
(12) Patent Application Publication
(10) Pub. No.: US 2021/0053057 A1
(43) Pub. Date: Feb. 25, 2021

(54) System and Method for Introducing Sample Material

(71) Applicant: Robert Bosch GmbH, Stuttgart (DE)

(72) Inventors: Jochen Hoffmann, Renningen (DE); Tino Frank, Luzern (CH); Christoph Faigle, Wolfratshausen (DE)

(21) Appl. No.: 17/050,385

(22) PCT Filed: Apr. 24, 2019
(86) PCT No.: PCT/EP2019/060439

§ 371 Date: Oct. 23, 2020

(30) Foreign Application Priority Data
Apr. 26, 2018 (DE) 10 2018 206 454.7

(51) Int. Cl. B01L 3/00

(52) U.S. Cl. CPC B01L 3/502715; B01L 2200/027; B01L 2300/0861; B01L 2300/0832; B01L 2200/0689

(57) ABSTRACT

A system for introducing sample material includes a microfluidic chip and a sample feeding zone disposed on or in the microfluidic chip. The sample feeding zone is configured to introduce the sample material into the microfluidic chip.

The invention relates to a system and a method for introducing sample material, located on a sample removal device, into a sample input region.

### PRIOR ART

The German laid-open specification DE 10 2005 050 347 A1 discloses a sample removal device, in particular a biopsy needle, composed of a hollow needle, having a distal opening with a peripheral edge, and of a stylet which is guided displaceably in the hollow needle and has a tip and a length such that the tip can protrude from the distal opening of the hollow needle. The sample removal device is configured, for example, as a fine needle biopsy device. The sample removal device or fine needle biopsy device is used to remove animal, human and/or plant tissue. In cases of suspected disease, fine needle biopsies are performed to remove tissue material or cells from the lungs, thyroid gland or prostate, for example. This sample material is traditionally placed onto a slide and assessed by a pathologist. The assessment involves visual examination of the morphology of the cells, for example. Cell-specific features are identified by what is known as immunohistochemical staining. In addition, genetic features of the cells are also increasingly being determined. The sample preparation steps that are needed for this are in most cases extensive and, consequently, are often not carried out directly. In some cases, this leads to treatments being prescribed without knowledge of relevant mutation states.

### DISCLOSURE OF THE INVENTION

The invention relates to an in particular microfluidic system for introducing sample material into a sample input region, wherein the sample input region for introduction of the sample material is provided on or in a microfluidic chip. The system preferably comprises the microfluidic chip. The system preferably comprises the sample input region, wherein the sample input region is in particular a part of the microfluidic chip.

In a preferred development, the system can also comprise a sample removal device. The sample removal device is, for example, a biopsy needle or a biodetector with a functional or functionalized surface. The functional or functionalized surface advantageously serves to isolate molecules or cells from the human body. Cells, in particular tumor cells, circulating in the blood stream can be removed from a patient with the biopsy needle. The functional or functionalized part of the biopsy needle is advantageously coated such that cells of epithelial origin, expressing a defined surface protein such as EpCAM, come into contact with the needle surface and are bound by antibodies present there, such as anti-Ep-CAM. The abbreviation Ep-CAM stands for epithelial cell adhesion molecule. In one use, the biopsy needle or the biodetector is introduced for example for thirty minutes into the brachial vein of a patient, removed and washed. A physician then determines the number of fixed cells and/or determines the mutation state of the cells. The microfluidic chip is, for example, a lab-on-a-chip of a lab-on-a-chip system. The microfluidic chip comprises a microfluidic network. The sample removal device is preferably configured as a biopsy needle and intended for use in a body, in particular a human body. To remove a sample, the biopsy needle is introduced for example into a vein in order to immobilize particles that circulate in the blood. The biopsy needle is then removed with the sample material, washed, stained and examined. The examination or processing, in particular a modification, of the sample material advantageously takes place in the microfluidic chip. A fully automated analysis of biological samples is thus easily made possible, directly at the point of care, by means of cost-effective disposable cartridges which comprise the microfluidic chip. On its functional surface, the sample removal device can also have mechanical structures which permit mechanical detachment of sample material from the body. The sample removal device can also comprise a filter device, for example, through which a liquid such as blood flows, wherein the sample material to be examined is filtered out. The microfluidic chip can be part of a microfluidic system comprising an appliance with which the microfluidic chip is processed. Reagents are advantageously present in the microfluidic chip. With the reagents, the sample material can then be prepared, for example washed.

A preferred illustrative embodiment of the system is characterized in that the sample input region on the microfluidic chip comprises an input channel for an in particular functional or functionalized part of the sample removal device with the sample material located thereon. The shape of the input channel is advantageously adapted to the shape of the sample removal device, in particular to the shape of the functional part of the biopsy needle. In this way, the insertion of the sample removal device, in particular of the functional part of the biopsy needle, into the microfluidic chip is considerably simplified.

A further preferred illustrative embodiment of the system is characterized in that the input channel is connected to a microfluidic network at at least one connection site. In this way, the preparation and/or processing of the sample material, for example the washing and staining of the sample material, are/is considerably simplified.

A further preferred illustrative embodiment of the system is characterized in that two channels of the microfluidic network issue from the input channel. This affords the advantage that the input channel, with the sample removal device arranged therein, can be washed quickly and easily with a suitable washing liquid. For this purpose, at least one micropump with a defined displacement volume, attached to the fluidic network, is advantageously integrated in the microfluidic chip.

A further preferred illustrative embodiment of the system is characterized in that the connection site is equipped with a fluid valve. The fluid valve is configured, for example, as a shut-off valve. With the shut-off valve, a connection between two channels in the microfluidic network can be blocked or enabled, depending on requirements, during the processing of sample material. This considerably simplifies the handling of the microfluidic chip during the preparation of the sample material, for example the washing, and during the subsequent processing.

A further preferred illustrative embodiment of the system is characterized in that the input channel issues from an attachment port on an outer face of the microfluidic chip. The attachment port comprises, for example, an insertion opening through which the sample removal device, in particular the functional part of the biopsy needle, is inserted into the input channel. This simplifies the handling of the sample removal device when introducing sample material into the microfluidic chip. The insertion opening can be closed by means of a suitable closure device, for example a closure stopper, before the sample removal device is inserted into the input channel.

A further preferred illustrative embodiment of the system is characterized in that the input channel has at least one bend. In this way, during the insertion of a flexible biopsy needle, space can advantageously be saved in the microfluidic chip.

A further preferred illustrative embodiment of the system is characterized in that the input channel extends at least partially in a spiral shape. This affords the advantage that the functional part of a flexible biopsy needle can be accommodated in a particularly space-saving manner in the microfluidic chip.

A further preferred illustrative embodiment of the system is characterized in that a sealing element is mounted on the sample removal device, which sealing element seals off an attachment port and/or the input channel from the environment of the microfluidic chip after the sample removal device has been inserted into the input channel.

In this way, an undesired escape of reagents from the input channel, with the sample removal device arranged therein, is safely avoided. The sealing element is particularly advantageously arranged behind a functional part of the sample removal device, in particular of the biopsy needle.

A further preferred illustrative embodiment of the system is characterized in that the microfluidic chip has, at a sealing location, a through-hole which is accessible from outside the microfluidic chip and which intersects the input channel and, after the insertion of the sample removal device into the input channel, is sealed by being filled with a sealing and/or adhesive material. In this way, a very effective sealing of the input channel, with the sample removal device arranged therein, can be easily achieved.

A further preferred illustrative embodiment of the system is characterized in that the input channel has a sealing recess in which a sealing element mounted on the sample removal device is received. In this way, an effective sealing of the input channel, with the sample removal device arranged therein, is ensured. In addition, a latching action can advantageously be effected as soon as the sealing element, which is preferably formed from an elastically deformable material, is received in the sealing recess during the insertion of the sample removal device into the input channel. The invention thus also relates to a sample removal device for a system according to the invention, wherein the sample removal device has a sealing element which seals off an attachment port and/or the input channel from the environment of the microfluidic chip after the sample removal device has been inserted into the input channel.

A further preferred illustrative embodiment of the system is characterized in that the sealing recess is arranged at a distance from the attachment port. The sealing effect can be improved in this way. If appropriate, the distance can also be zero. That is to say, the sealing recess can also be arranged directly at the attachment port.

A further preferred illustrative embodiment of the system is characterized in that the sealing recess has, at least in part, the shape of a truncated cone which tapers in a direction of insertion of the sample removal device. A base surface of the truncated cone advantageously faces toward the attachment port. The frustoconical shape of the sealing recess can advantageously allow the sealing element to engage with a latching or snap-fit action into the sealing recess during the insertion of the sample removal device into the input channel.

A further preferred illustrative embodiment of the system is characterized in that the sample removal device hooks with the sealing element in the sealing recess like a barb. The sealing element is advantageously connected rigidly, at least axially rigidly, to the sample removal device, in particular the biopsy needle. By means of the hooking of the sealing element in the sealing recess, the sample removal device is safely held with the functional part in the input channel.

A further preferred illustrative embodiment of the system is characterized in that the sealing element is formed from a viscous material which surrounds the sample removal device and fills the sealing recess. The viscous material can be solidified or cured, preferably with light, as soon as the sealing element fills the sealing recess. This ensures that the sample removal device with its functional part is secured in a particularly stable manner in the input channel.

A further preferred illustrative embodiment of the system is characterized in that the sealing element is fixed in the axial direction on the sample removal device. In the same way as with O-rings for example, the fixing of the sealing element can be secured by a suitably shaped annular groove on the sample removal device. Alternatively or additionally, however, the sealing element can also be connected cohesively to the sample removal device in order to fix the sealing element on the sample removal device.

A further preferred illustrative embodiment of the system is characterized in that the sealing element is configured as an O-ring. The production costs can be reduced in this way.

A further preferred illustrative embodiment of the system is characterized in that the sealing element has, at least in part, the shape of a truncated cone. The shape of the sealing element is advantageously adapted to the shape of the sealing recess. Sufficient sealing is easily achieved in this way.

A further preferred illustrative embodiment of the system is characterized in that the sealing element is configured as a capsule which contains at least one adhesive component and which is broken open by mechanical action during the insertion of the sample removal device into the input channel. The capsule advantageously comprises several adhesive components. After the capsule has broken open, the adhesive components mix together and harden. This ensures very effective sealing of the input channel with the sample removal device located therein. The curing of an adhesive component or of several adhesive components can also be initiated by light, in particular UV light.

A further preferred illustrative embodiment of the system is characterized in that the input channel has a Luer lock attachment for the sample removal device. By means of a Luer lock connection, good sealing of the input channel, with the sample removal device arranged therein, is ensured in a simple way. In addition, the Luer lock connection simplifies the handling of the sample removal device and of the microfluidic chip.

A further preferred illustrative embodiment of the system is characterized by a sample input device, which receives the in particular functional part of the sample removal device with the sample material located thereon. In this way, the reception of the sample removal device, with the sample material located thereon, can be decoupled from the microfluidic chip. This affords the advantage that a change of shape of the sample removal device, for example a bending of a flexible biopsy needle, can be effected independently of the microfluidic chip. This simplifies the handling of the sample input device during a change of shape of the sample removal device. For example, after a change of shape of the sample removal device, the sample input device can be combined, together with the sample removal device and the sample material located thereon, with the microfluidic chip. In doing this, the sample material located on the sample removal device is advantageously arranged in the sample input region of the microfluidic chip, if appropriate in a further handling step.

A further preferred illustrative embodiment of the system is characterized in that the sample input device comprises a receiving body or a receiving space for receiving a preferably flexible part of the sample removal device with the sample material located thereon. The flexible part of the sample removal device is, for example, a functional or functionalized portion of a biopsy needle with the sample material located thereon. The preferably flexible part of the sample removal device, with the sample material located thereon, can advantageously be accommodated in the receiving space of the sample input device in a particularly space-saving manner.

A further preferred illustrative embodiment of the system is characterized in that the sample input region on the microfluidic chip comprises a recess for applying the sample input device with the part of the sample removal device and with the sample material located thereon. This further simplifies the introduction of the sample material into the microfluidic chip.

A further preferred illustrative embodiment of the system is characterized in that the sample input device comprises a hollow space with a holder with a specifically deformed part of the sample removal device with the sample material located thereon. In the specific deformation, the part of the sample removal device, in particular the functional or functionalized part or portion of the biopsy needle, is preferably bent. The wall of the hollow space serves particularly advantageously as a clamping holder against which the biopsy needle presses when it is bent or rolled.

A further preferred illustrative embodiment of the system is characterized in that the part of the sample removal device with the sample material located thereon is bent, at least in part, in the shape of an arc of a circle. In this way, the part of the sample removal device with the sample material located thereon can be advantageously accommodated in a particularly space-saving manner.

A further preferred illustrative embodiment of the system is characterized in that the part of the sample removal device with the sample material located thereon is specifically deformed only in one plane. In this way, the part of the sample removal device with the sample material located thereon is easily able to be accommodated in a particularly space-saving manner in the sample input region of the microfluidic chip.

A further preferred illustrative embodiment of the system is characterized in that the sample input device comprises a hollow cylinder with an attachment for the microfluidic chip. The hollow cylinder is easy to produce and provides a sufficiently large receiving space for the part of the sample removal device with the sample material located thereon. The attachment for the microfluidic chip is, for example, simply a through-hole which connects the receiving space to the fluidic network of the microfluidic chip.

A further preferred illustrative embodiment of the system is characterized in that the sample input device comprises a receiving body with a spiral-shaped receiving channel for the part of the sample removal device with the sample material located thereon. The receiving body has, for example, the shape of a straight circular cylinder. The spiral-shaped receiving channel is advantageously introduced into the outer jacket surface of the receiving body. The spiral-shaped receiving channel can be generated in the receiving body by milling, for example. However, the spiral-shaped receiving channel can also be formed with a suitable tool, for example by injection molding or by primary forming, if the receiving body is made of a suitable casting material, in particular a plastics material. The receiving body with the spiral-shaped receiving channel is advantageously accommodated, together with the part of the sample removal device arranged in the receiving channel and with the sample material located thereon, in a hollow cylinder before the receiving body, with the part of the sample removal device, is applied together with the hollow cylinder to the microfluidic chip.

A further preferred illustrative embodiment of the system is characterized in that the sample input device comprises a receiving body with a receptacle for an end or a portion of the part of the sample removal device with the sample material located thereon. The part of the sample removal device with the sample material located thereon is arranged with the end or with the portion in the receiving body, before the receiving body is moved, in particular rotated, in order to wind the part of the sample removal device, with the sample material located thereon, onto the receiving body. The handling of the sample removal device is further simplified in this way.

A further preferred illustrative embodiment of the system is characterized in that the receiving body comprises an input channel for the part of the sample removal device with the sample material located thereon. This affords the advantage that the part of the sample removal device with the sample material located thereon, in particular a flexible functional or functionalized portion of the biopsy needle, can be easily pushed into the receiving body in order to introduce the sample material into the receiving body.

A further preferred illustrative embodiment of the system is characterized in that the input channel has at least one bend. In this way, the sample removal device with the sample material located thereon can easily be accommodated in a particularly space-saving manner in the receiving body.

A further preferred illustrative embodiment of the system is characterized in that the input channel extends at least in part in a spiral shape. The flexible portion of the biopsy needle can then easily be brought into a desired spiral shape before the receiving body is brought together with the microfluidic chip.

A further preferred illustrative embodiment of the system is characterized in that the receiving body, with the end or portion of the part of the sample removal device and with the sample material located thereon, is arranged rotatably in order to wind the part of the sample removal device, with the sample material located thereon, onto the receiving body. This simplifies the handling of the sample removal device and at the same time allows the sample material to be accommodated in a particularly space-saving manner.

A further preferred illustrative embodiment of the system is characterized in that the receiving body, with the part of the sample removal device and with the sample material located thereon, is movable into a recess of the microfluidic chip with the sample input region when pressure is applied to the receiving body. In this way, incorrect operations when introducing the sample material into the microfluidic chip can easily be avoided.

A further preferred illustrative embodiment of the system is characterized in that the receiving body is guided in a guide body provided on the microfluidic chip. The guide body is formed, for example, by a hollow cylinder. The receiving body is advantageously received in the guide body both rotatably and axially displaceably. The functionality of the sample input device can advantageously be increased in this way.

A further preferred illustrative embodiment of the system is characterized in that the guide body has at least one insertion opening for the part of the sample removal device with the sample material located thereon. The sample removal device, in particular the biopsy needle, can easily be pushed in through the insertion opening. After it has been pushed in, the preferably flexible biopsy needle is then brought to a desired shape in the receiving body.

A further preferred illustrative embodiment of the system is characterized in that the guide body has two diametric openings for the passage of the part of the sample removal device with the sample material located thereon. During insertion, the sample removal device, in particular the biopsy needle, is first of all pushed through the first opening, then through the receiving body, and finally through the second opening of the two diametric openings. By rotation of the receiving body, the part of the sample removal device with the sample material located thereon can then be wound very conveniently and quickly onto the receiving body.

A further preferred illustrative embodiment of the system is characterized in that the guide body has an abutment body which permits a rotation of the receiving body and prevents a translatory movement of the receiving body onto the microfluidic chip. In this way, undesired incorrect operations of the receiving body can be safely prevented when winding on the part of the sample removal device with the sample material located thereon. Only when the winding process has been completed is the wound-on sample removal device arranged in the input region of the microfluidic chip.

A further preferred illustrative embodiment of the system is characterized in that the abutment body has at least one predetermined breaking point which, upon its activation, enables the translatory movement of the receiving body on the microfluidic chip. In this way, after the end of the winding-on process, the part of the sample removal device with the sample material located thereon can be quickly and safely arranged in the input region of the microfluidic chip, in particular by exerting manual pressure on the receiving body.

A further preferred illustrative embodiment of the system is characterized in that the receiving body is provided with a seal which seals off the sample input region, on or in the microfluidic chip, from the environment. The seal can be configured in a manner similar to an O-ring, which is arranged in a corresponding annular groove of the receiving body. In the translatory movement of the receiving body with the seal onto the microfluidic chip, the seal is then arranged in the region of at least one input opening or the two above-described openings for the passage of the part of the sample removal device with the sample material located thereon, such that the opening or the openings are safely closed. The seal is advantageously brought automatically to the desired sealing position when the receiving body is pressed down.

In a preferred embodiment, either some or all of the sample input region, network, sample input device, attachment, adapter part and so on are coated such that adsorption of sample material on channel walls is minimized. This can be done, for example, by wet chemical surface modification or depositions from the gas phase. For example, silanes such as PFOTS or APTES in solvents such as FC-40 or n-heptane can be deposited on corresponding surfaces in order to minimize interactions between the sample material and contact faces of the chip. The abbreviation PFOTS stands for perfluorooctyl-trichlorosilane. The abbreviation APTES stands for 3-aminopropyltriethoxysilane. FC-40 is a fluorinated solvent from the company 3M. The n-heptane is a straight-chain hydrocarbon from the substance group of the alkanes.

After deduction of a volume of the part of the sample removal device with the sample material located thereon, in particular of the wire volume of the biopsy needle or the functional or functionalized portion of the biopsy needle with the sample material, the sample input region, which is preferably configured as a sample input chamber, preferably has a liquid volume of one to one hundred microliters, preferably between ten microliters and fifty microliters. The channels, in particular the input channels, but also the other channels of the sample removal device or of the microfluidic chip, can have round, angular or polygonal cross sections. Typical structural sizes of the channels are between ten micrometers and one millimeter. The frustoconical or conical cutout of the above-described sealing recess can have a round cross section. A typical diameter of the base surface of the cone or of the frustum is between one and five millimeters.

The sample removal device is, for example, a fine biopsy needle with immobilized sample material. Very small tissue sections, generally tumor tissue, are immobilized. The functional or functionalized portion of the biopsy needle is preferably a functionalized wire with immobilized cells, that is to say circulating tumor cells, blood cells and/or immune cells. The functionalized wire is advantageously provided with bound deoxyribonucleic acid, ribonucleic acid, protein, lipid, cells, bacteria. The functional or functionalized part of the biopsy needle can also comprise functionalized magnetic wire with magnetic beads which carry sample material such as proteins. The beads or particles are of the order of magnitude of nanometers to millimeters. The magnetic beads are formed, for example, from a magnetic or magnetizable material, in particular a ferromagnetic material.

The invention further relates to a microfluidic chip, a sample input device, a receiving body and/or a seal for an above-described system. The stated parts can be handled separately.

A method for introducing sample material, located on a sample removal device, into a sample input region is characterized in that a part of the sample removal device is arranged in the sample input region of a microfluidic chip in order to introduce the sample material located on the sample removal device into the microfluidic chip, in particular into a microfluidic chip of an above-described system. The sample removal device comprises, for example, a biopsy needle with a functional or functionalized portion which is arranged directly in the sample input region of the microfluidic chip. However, the sample removal device can also firstly be arranged in a sample input device, before the sample removal device is then arranged, together with the sample input device, in the sample input region of the microfluidic chip.

The following advantages can be achieved: Suitable microfluidic structures permit input of biopsy needles onto a lab-on-a-chip. This permits the fully automated analysis of tissue/cells at the point of care and thus permits almost real-time availability of genetic results. With a sample input possibility for microfluidic systems, analyses can be performed in the field of oncology, which extends the application spectrum of a lab-on-a-chip system. Biopsy needles are inserted into microscopic volumes. This permits the transfer of the biological sample material into a microfluidic volume. Compared to the prior art, this has for example the advantage that the samples are present in a liquid phase at a higher concentration. In addition to genetic analyses of the cells, it is also possible for cells to be stained and counted on a lab-on-a-chip. Moreover, the steps of counting the cells and genetically analyzing the cells can be carried out in succession, which increases the information content regarding pathological states of the cells. The integration on the lab-on-a-chip guarantees that each bound cell is processed. This is helpful in particular when the number of cells is very low. Possible cell losses caused by handling in external processing can be avoided. The input principle permits a direct transfer of the sample material from the sample source (generally patients) onto the analysis platform. This reduces the number of manual steps many times over. It is not only errors by laboratory personnel that are reduced, but also the sources of possible contamination. The analysis takes place largely in a closed system. Since all of the required chemicals can already be stored in advance on the lab-on-a-chip analysis unit, direct needle insertion does not require additional chemicals to be stored in containers. This makes a product more user-friendly.

Further advantages, features and details of the invention will become clear from the following description in which various illustrative embodiments are described in detail with reference to the drawing.

### BRIEF DESCRIPTION OF THE DRAWING

FIG. 1 shows a schematic view of a microfluidic chip with a microfluidic network and with a sample input region;

FIG. 2 shows a detail from FIG. 1 with the sample input region and with a through-hole which extends through an input channel of the microfluidic chip;

FIG. 3 shows the same detail as in FIG. 2, with a sealing recess in the input channel;

FIG. 4 shows the same detail as in FIGS. 2 and 3, with a Luer lock attachment;

FIG. 5 shows a sample removal device configured as a biopsy needle;

FIG. 6 shows the sample removal device from FIG. 5, with a sealing element configured as an O-ring;

FIG. 7 shows the sample removal device from FIG. 5, with a sealing element made of a deformable viscous material;

FIG. 8 shows the sample removal device from FIG. 5, with a frustoconical sealing element;

FIG. 9 shows the sample removal device from FIG. 5, with a Luer lock male body;

FIG. 10 shows a sample removal device which is configured as a biopsy needle with an adapter and which has a functional or functionalized end portion;

FIG. 11 shows the sample removal device from FIG. 10, with a deformed functional end portion together with a microfluidic chip, which is combined with a sample input device;

FIGS. 12 to 15 show an illustrative embodiment of the sample input device from FIG. 11 in different views;

FIGS. 16 and 17 show a second illustrative embodiment of the sample input device from FIG. 11 in a perspective view;

FIGS. 18 to 20 show a third illustrative embodiment of the sample input device from FIG. 11 in three sectional views;

FIGS. 21 to 23 show a fourth illustrative embodiment of the sample input device from FIG. 11 in three views; and

FIGS. 24 and 25 show a detail of the sample input device from FIG. 11, with a sealing element in section in two operating positions.

### DESCRIPTION OF THE ILLUSTRATIVE EMBODIMENTS

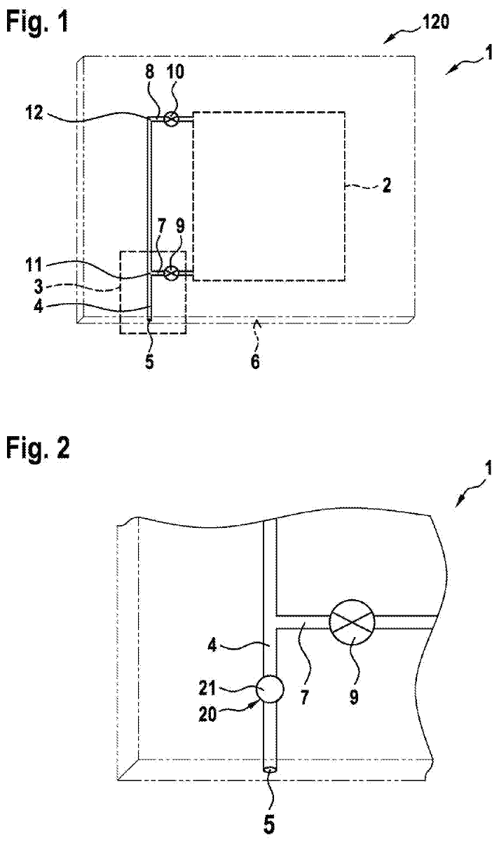

FIG. 1 shows a schematic view of an illustrative embodiment of the system 120 according to the invention for introducing sample material with a microfluidic chip 1. The microfluidic chip 1 is configured in one piece, with an input possibility for a biopsy needle. However, the microfluidic chip 1 can also have a multi-part configuration.

The microfluidic chip 1 comprises a microfluidic network which is connected to a sample input region 3. The sample input region 3 comprises an input channel 4. The input channel 4 issues from an attachment port 5 on an outer face 6 of the microfluidic chip 1.

The input channel 4 has two connection sites 11, 12, which constitute fluidic branches. A first channel 7 issues from the connection site 11 of the input channel 4. A second channel 8 issues from the connection site 12 of the input channel 4. By way of the channels 7, 8, the input channel 4 is connected to the fluidic network 2 of the microfluidic chip 1.

A fluid valve 9, 10 is arranged at each of the connection sites 11, 12. With the fluid valves 9, 10, the connection between the input channel 4 and the channels 7, 8 at the connection sites 11, 12 can be blocked or enabled, depending on requirements, during the processing of sample material in the sample input region 3. By way of the fluid valves 9, 10, the input channel 4 can be uncoupled from or coupled to the microfluidic network 2 during the processing of sample material.

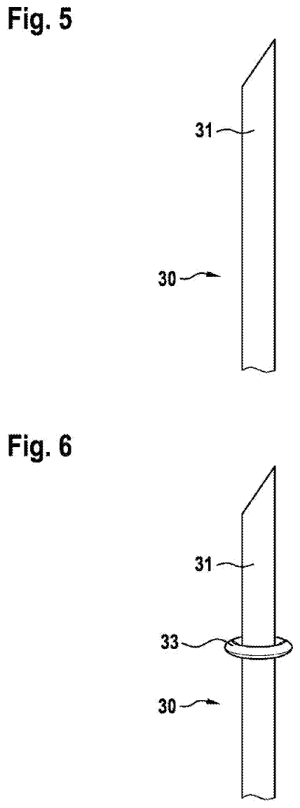

FIG. 5 shows an illustrative embodiment of a sample removal device 30. The sample removal device 30 is equipped as biopsy needle with an in particular functional region 31. Sample material adheres to the in particular functional region 31 of the biopsy needle 30, said sample material having been removed with the aid of the sample removal device 30 from a body, for example from a vein of a human body.

The biopsy needle 30 to be examined is introduced into the input channel 4 of the microfluidic chip 1 via the attachment port 5. The attachment port 5, which is also designated as a closure port 5, fluidically and pneumatically seals off the interior of the microfluidic chip 1 configured as a cartridge, after the biopsy needle (30 in FIG. 5) has been introduced into the input channel 4. For the sealing, the biopsy needle 30, as is indicated in FIGS. 6 to 8, can have an additional sealing element 33; 35; 37. The sealing element 33; 35; is advantageously arranged behind the functional region 31 (also designated as an active tip) of the biopsy needle 30.

FIG. 2 shows that the microfluidic chip 1, which can constitute a lab-on-a-chip, is advantageously equipped with a sealing recess 20. The sealing recess 20 comprises a through-hole 21 which extends, transversely with respect to the input channel 4, through the microfluidic chip 1. The through-hole 21 intersects the input channel 4, wherein the through-hole 21 has a much greater diameter than the input channel 4.

The through-hole 21 can, for example, be drilled into the microfluidic chip 1, configured as a cartridge, or milled or embossed. After the biopsy needle 30 has been inserted into the input channel 4, the through-hole 21 is advantageously completely filled with an adhesive in order to seal it. By means of the adhesive, the input channel 4, with the biopsy needle 30 located therein, is sealed off from the environment of the microfluidic chip 1 in FIG. 2 above the through-hole 21.

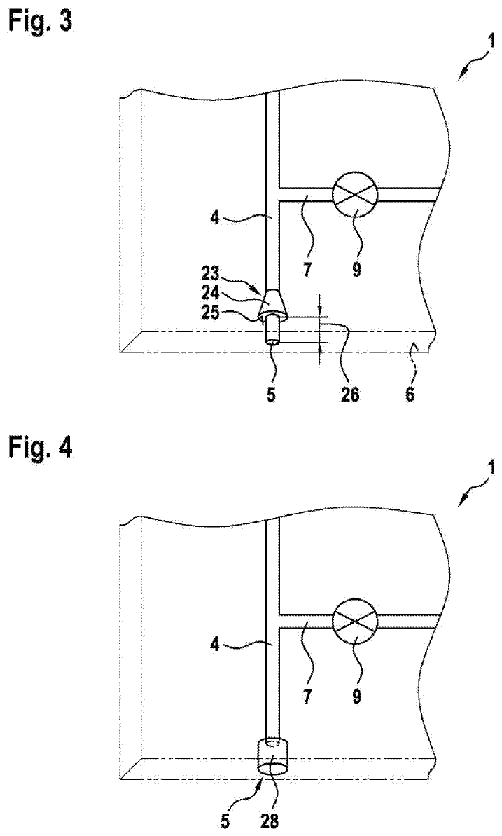

FIG. 3 shows that the input channel 4 can also be equipped, for sealing purposes, with a sealing recess 23. The sealing recess 23 has the shape of a truncated cone 24. The truncated cone 24 has a base surface 25 which is arranged at a distance 26 from the outer face 6 of the microfluidic chip 1. The distance 26 can also be zero.

For sealing purposes, one of the sealing elements 33; 35; 37, which can be mounted on the biopsy needle 30 as shown in FIGS. 6, 7 and 8, can be received in the frustoconical sealing recess 23 of the input channel 4.

The illustrative embodiment of the sealing element 33 shown in FIG. 6 consists of a compressible O-ring which encloses the biopsy needle 30. During the insertion or input of the biopsy needle 30 into the input channel 4, the sealing element 33 configured as an O-ring is received irreversibly, like a barb, in the frustoconical sealing recess 23.

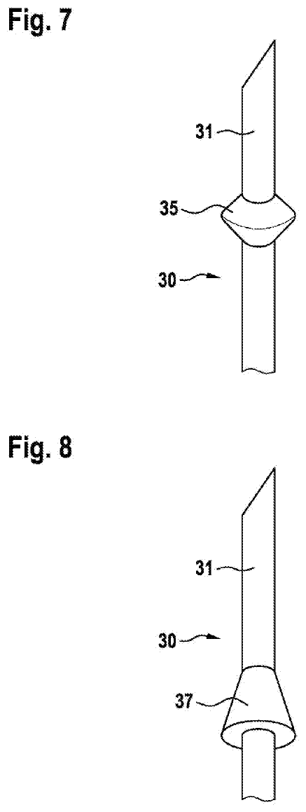

FIG. 7 shows that the sealing element 35 can also be formed from a deformable viscous material which completely fills the frustoconical sealing recess 23 upon input or insertion of the biopsy needle 30 into the input channel 4. Thereafter, the material can be cured, for example with light, in order to give the sealing element 35 a solid shape.

According to the particularly preferred illustrative embodiment shown in FIG. 8, the sealing element 37 is composed of a conical or frustoconical capsule which comprises at least one adhesive component, preferably several adhesive components. The capsule is broken open by mechanical action during the insertion or input of the biopsy needle 30 into the input channel 4, as a result of which the adhesive components mix together and seal off the sealing recess 23 with the biopsy needle, if appropriate after UV exposure.

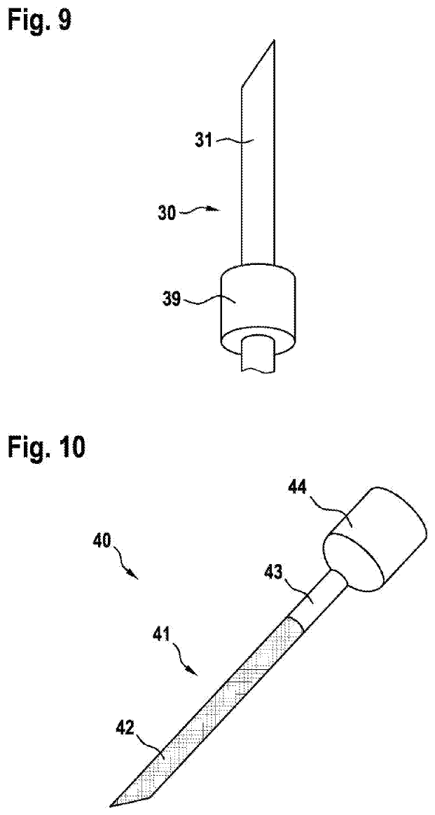

FIGS. 4 to 9 show that the sealing of the input channel or of the attachment port 5 can also be effected by Luer lock connection. In FIG. 4, the attachment port 5 is configured as a Luer lock recess 28. The Luer lock recess 28, also designated as a female recess, is configured to complement a Luer lock plug part 39 on the biopsy needle 30, as shown in FIG. 9. The Luer lock plug part 39 can also be designated as a male plug part. During the insertion of the biopsy needle 30 with the functional part 31 into the input channel 4, the Luer lock plug part 39 is received sealingly in the Luer lock recess 28 of the microfluidic chip 1.

FIG. 10 shows an illustrative embodiment of a sample removal device 40 which is configured as a biopsy needle with a functional or functionalized part 42. The functional or functionalized part 43 is provided, for example, with a special coating. The biopsy needle 41 additionally comprises a non-functional part 43, at the free end of which an adapter part 44 is provided. The non-functional part 43 is preferably not coated, but it can be formed from the same material as the functional part 42.

During the removal of sample material, the sample material that is to be examined advantageously adheres to the functional part 42 of the biopsy needle 40. The adapter 44 permits manual use of the biopsy needle 41. For the processing, only the functional part 42 and as little as possible of the non-functional part 43 of the biopsy needle 41 is advantageously placed onto the lab-on-a-chip platform.

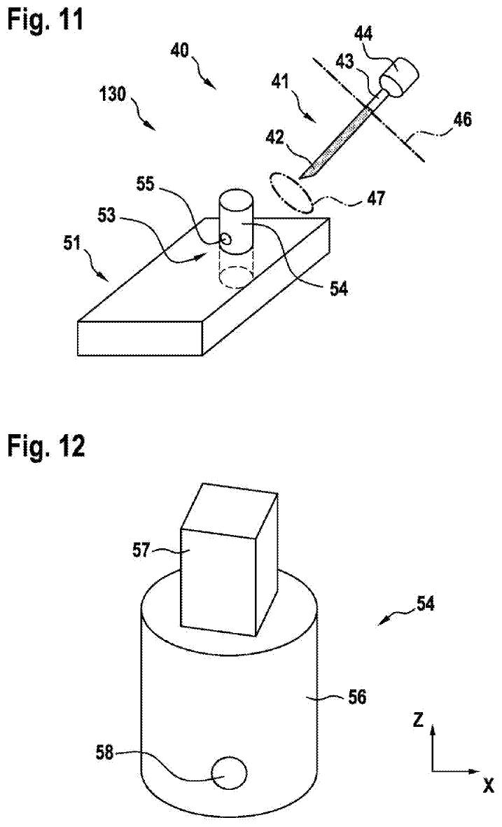

FIG. 11 shows a schematic view of an illustrative embodiment of a system 130 for introducing sample material, with a microfluidic chip 51 which constitutes a lab-on-a-chip system or belongs to a lab-on-a-chip system. Above the microfluidic chip 51, a line 46 indicates that the functional part 42 is separated from the adapter 44 and the non-functional part 43 of the sample removal device 40 configured as biopsy needle 41.

FIG. 11 additionally indicates, by means of a circle 47 at the end of the functional part 42 of the biopsy needle 41, that the shape of the functional part 42 is advantageously changed such that the functional part 42 of the biopsy needle 41 fits into a sample input device 54, which constitutes a sample chamber. The sample input device 54 can then be arranged, with the re-shaped functional part 42 of the biopsy needle 41, in a sample input region 53 of the microfluidic chip 51.

The functional part 42 of the biopsy needle 41 is formed, for example, from an elongate wire which, as is indicated by the circle 47 in FIG. 11, is converted into a rounded shape. For this purpose, it is advantageous that the biopsy needle 41 is made of a bendable or flexible material. The change of shape of the functional part 42 of the biopsy needle 41 affords the advantage that the functional part 42, preferably formed from wire, can be accommodated in a particularly space-saving manner in the sample input region 53 on the lab-on-a-chip 51.

For the application of the sample input device 54, the microfluidic chip 51 advantageously comprises a recess 55, the shape of which is adapted to the sample input device 54. The sample input region 53 of the microfluidic chip 51 is arranged in the recess 55.

FIGS. 12 to 15 show an illustrative embodiment of the sample input device 54 in different views. The sample input device 54 comprises a hollow cylinder 56 with an adapter part 57 which constitutes a handle for the manual use of the sample input device 54. The hollow cylinder 56 additionally comprises an attachment 58 for the microfluidic chip (51 in FIG. 11).

The hollow cylinder 56 delimits a hollow space 59 which, at an end of the hollow cylinder 56 directed away from the adapter 57, constitutes a receiving space 60 for the functional part 42 of the biopsy needle 41. A holder 61 for the functional part 42 of the biopsy needle 41 is arranged in the receiving space 60. The holder 61 has the shape of a cuboid with a slot 62 in which an end or a portion of the functional part 42 of the biopsy needle 41 can be clamped.

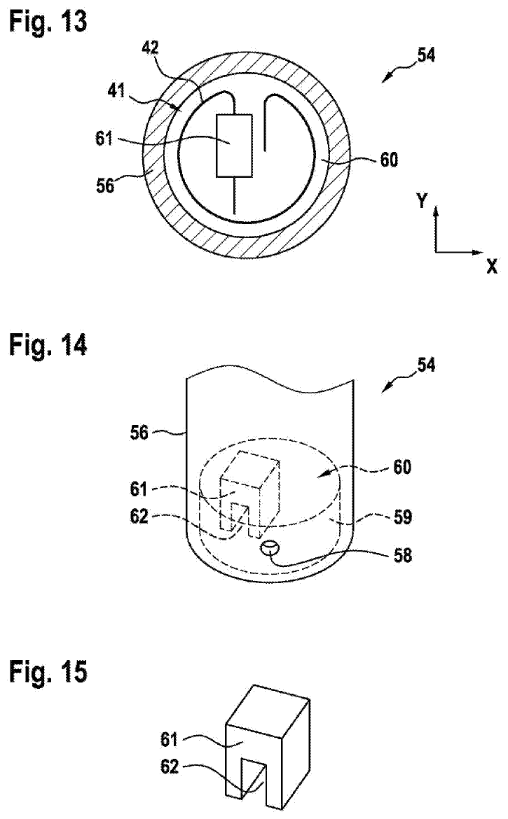

FIG. 13 shows that the biopsy needle 41 formed from wire, with the functional part 42, is brought into an annular geometry. In FIG. 14, the hollow space 59 which constitutes the receiving space 60 for the biopsy needle 41 is shown in perspective and by broken lines. In FIG. 15, the holder 61 with the slot 62 is shown in perspective on its own.

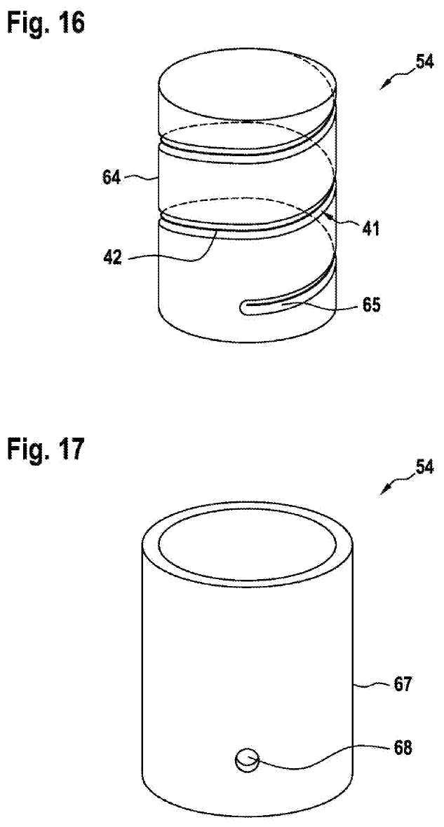

FIGS. 16 and 17 show that the sample input device 54 can also comprise a receiving body 64 with a spiral-shaped receiving channel 65. The receiving body 64 has the shape of a straight circular cylinder and can also be designated as a stopper. The spiral-shaped receiving channel 65 is milled as a channel spiral, for example from the top downward, into the stopper or receiving body 64.

To constitute the sample input device 54, the receiving body 64 is arranged in a hollow cylinder 67, which is shown in perspective on its own in FIG. 17. The hollow cylinder 67 has an attachment 68 for the microfluidic chip (51 in FIG. 11). The attachment 68 is configured as a through-hole in the hollow cylinder 67 and permits access to the microfluidic network of the lab-on-a-chip 51.

The biopsy needle 41 is advantageously brought into the desired spiral shape by being pushed into the receiving channel 65. The hollow cylinder 67, which together with the stopper 64 and the functional part 42 of the biopsy needle 41 constitutes the sample input device 54, can then be fluidically controlled via the attachment 68 through the microfluidic chip 51. The combination of the milled receiving body 64 and of the relatively thin hollow cylinder 67 simplifies the production of the claimed system.

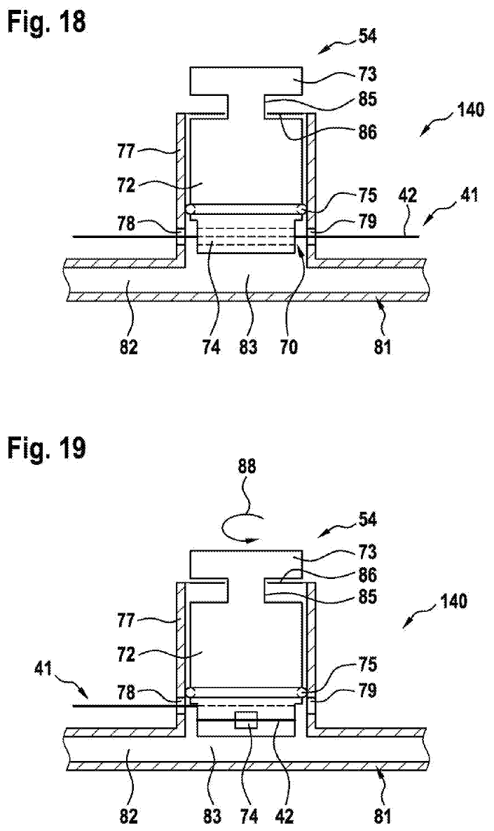

FIGS. 18 to 20 show an illustrative embodiment of the sample input device 54 as a rotary device in different views and operating positions in a system 140 for introducing sample material. The sample input device 54 comprises a receiving body 72 with an adapter part 73 which permits manual operation of the sample input device 54. The receiving body 72 comprises an input channel 74 for the functional part 42 of the biopsy needle 41. Above the input channel 74, the receiving body 72 has a seal 75.

The receiving body 72 is rotatable in a hollow cylinder 77, which constitutes a guide body for the receiving body 72. The hollow cylinder 77 is in particular configured integrally with a microfluidic chip 81. The microfluidic chip 81 comprises a microfluidic network 82 and a sample input region 83.

Above the sample input region 83 of the microfluidic chip 81, the hollow cylinder 77 has two openings 78, 79 which are arranged diametrically and, as is shown in FIG. 18, allow passage of the biopsy needle 41. It is indicated in FIG. 18 that the biopsy needle 41 is firstly clamped with its functional part 42 in the input channel 74 of the receiving body 72.

An arrow 88 in FIG. 19 indicates that the functional part 42 of the biopsy needle 41 is then converted to the desired annular form or shape by rotation of the receiving body 72 in the hollow cylinder 77. The input channel 74 constitutes a clamping device for the functional part 42 of the biopsy needle 41.

The clamping device is located planar to the two openings 78, 79 in the hollow cylinder 77, which constitutes a sample input chamber. In addition, in the region of the openings 78, 79 of the hollow cylinder 77, the receiving body 72 constituting a rotary cylinder has a constriction or a shoulder. In the hollow cylinder 77 above the sample input region 83, the constriction or the shoulder constitutes a hollow space, in particular an annular space, which serves to receive the wound wire of the functional part 42 of the biopsy needle 41. The volume of the sample chamber is easily controllable via this hollow space, in particular this annular space. By means of rotation, the biopsy needle 41 is drawn in and at the same time brought into the correct form or shape.

At its upper end below the adapter or adapter part 73, the receiving body 72 configured as a rotary cylinder has an annular groove 85 in which an abutment body 86 engages. The abutment body 86 protrudes radially inward from the hollow cylinder 77 and is provided with at least one predetermined breaking point. By means of the abutment body 86 with the predetermined breaking point, the receiving body 72 constituting the rotary cylinder is maintained at the correct height during the rotation.

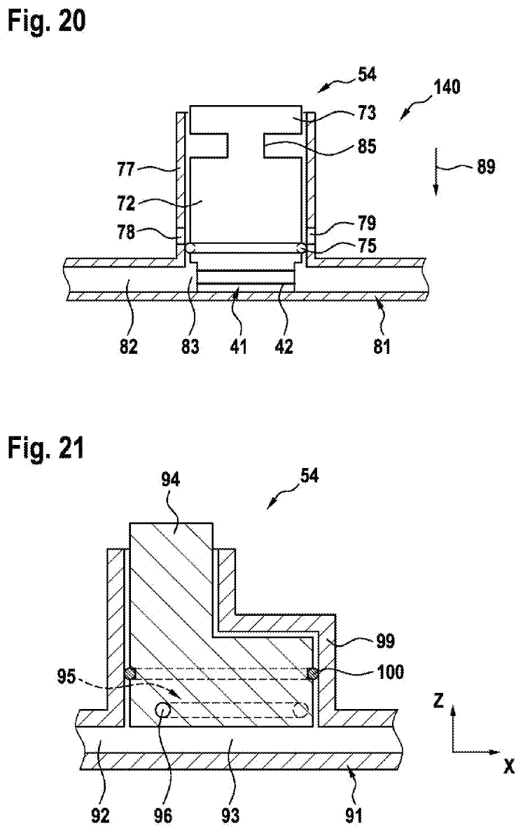

When the functional part 42 of the biopsy needle 41 is rolled up or wound up, the receiving body or rotary cylinder 72 is pressed downward, advantageously by hand, as is indicated in FIG. 20 by an arrow 89. The predetermined breaking point of the abutment body 86 is thus broken. At the same time, the functional part 42 of the biopsy needle 41, wound onto the lower end of the receiving body 72, is arranged as desired in the sample input region 83 of the microfluidic chip 81.

During the pressing down of the receiving body 72, the seal 75 is additionally arranged under the openings 78, 79 in the hollow cylinder 77, such that the sample input region 83 with the functional part 42 of the biopsy needle 41 is sealed off. In this way, an undesired escape of liquids from the microfluidic network or system is safely avoided.

FIGS. 21 to 23 show an illustrative embodiment of a microfluidic chip 91 with a microfluidic network 92 and a sample input region 93 with a sample input device 54 in different views. The sample input device 54 comprises a receiving body 94 with an input channel 95 which, as is shown in FIG. 23, extends in a helical shape through the receiving body 94 in a plane spanned by an x axis and a y axis. The input channel 95 issues from an insertion opening 96 through which the biopsy needle 41 can be inserted with its functional part 42.

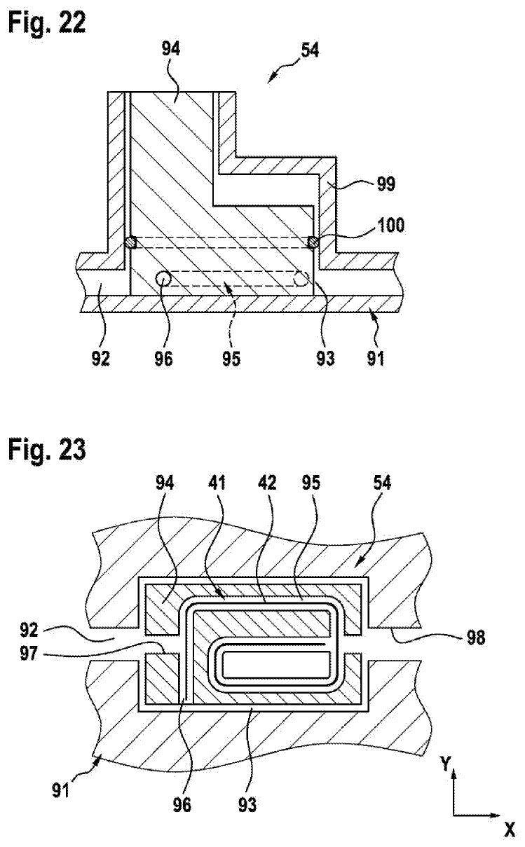

In addition, FIG. 23 shows that the receiving body 94 has two connection openings 97, 98 which connect the input channel 95 to the microfluidic network 92 in the microfluidic chip 91. The receiving body 94 is displaceable in translation from the top downward in a guide body 99, as is seen by comparing FIGS. 21 and 22.

The guide body 99 advantageously comprises an insertion opening (not shown) which, in the state of the receiving body 94 shown in FIG. 21, is arranged in alignment with the insertion opening 96. This affords the advantage that the functional part 42 of the biopsy needle 41 can be easily inserted through the two openings into the input channel 95.

During the insertion or pushing in of the functional part of the biopsy needle 41, which is preferably formed from a flexible wire, the biopsy needle 41 than adopts the shape shown in FIG. 23. A seal 100 is mounted on the receiving body 94 and seals off the sample input region 93, as is shown in FIG. 22, after the for example manual pressing down of the receiving body 94.

In contrast to what is shown, the receiving body 94 can be configured as a solid stopper, which is not movable in the guide body 91. The biopsy needle 41 can then be pushed, for example via a correspondingly shaped input channel 95 through the receiving body 94, into the sample input region 93 of the microfluidic chip 91.

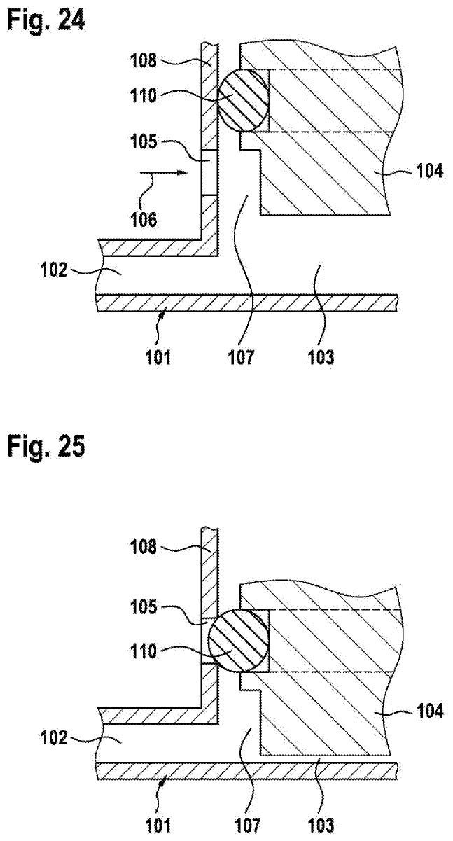

FIGS. 24 and 25 show an illustrative embodiment of a microfluidic chip 101 with a microfluidic network 102 and with a sample input region 103 with a receiving body 104 in different positions, in order to explain the function of a seal 110 which is mounted on the receiving body 104. The receiving body 104 is movable in translation in a guide body 108.

An arrow 106 in FIG. 24 indicates that the functional part of a biopsy needle can be inserted through an input opening 105 into an annular space 107 which, for example, corresponds to the annular space described, but not specifically designated, in FIGS. 18 to 20. The seal 110 is configured, for example, as a silicone O-ring and is arranged in an annular groove of the receiving body 104.

In FIG. 24, the seal 110 is arranged above the input opening or insertion opening 105. When the receiving body 104, also designated as a plug, is pressed down, the sealing ring 110, as seen in FIG. 25, seals off the input opening 105.

The parts of the illustrative embodiments described with reference to FIGS. 1 to 25 can be produced cost-effectively in large batch numbers by injection molding or by means of co-extrusion from suitable plastics. Alternatively or additionally, known three-dimensional printing methods can be used. In addition, machining methods such as milling or other subtractive methods, for example laser ablation, can advantageously be used.

The parts, in particular the adapter parts, can be made of or formed from, inter alia, polymer materials such as PC, COC, COP, PMMA, PTFE, PEEK, ABS, PE, PDMS. Moreover, all or individual parts can be made of or formed from metallic materials, in particular aluminum materials. To provide closure caps, elastic materials such as PTU, TPE, PDSM, rubber or polyurethane can additionally be used.

The closure of the through-hole 21 in FIG. 2 is effected, for example, with a viscous UV adhesive or with a hot-melt adhesive. Typical process temperature ranges lie between twenty and sixty degrees Celsius. The viscosities of the viscous adhesive material lie advantageously between one thousand and five thousand centipascals.

The seals and sealing elements can be formed, for example, from industrial plasticine or from a two-component adhesive. The sealing elements configured as O-rings are formed, for example, from FFPM, PE, PTFE. The abbreviations used above in capital letters are short forms that are customarily used to designate plastics.

1. A system for introducing sample material, comprising:
a microfluidic chip; and
a sample input region disposed on or in the microfluidic chip, the sample input region configured to introduce the sample material.

2. The system as claimed in claim 1, further comprising a sample removal device.

3. The system as claimed in claim 2, wherein the sample input region on the microfluidic chip comprises an input channel for a part of the sample removal device with the sample material located thereon.

4. The system as claimed in claim 3, wherein the input channel is connected to a microfluidic network at at least one connection site.

5. The system as claimed in claim 3, wherein a sealing element is mounted on the sample removal device, the sealing element configured to seal off one or more of an attachment port and the input channel from the environment of the microfluidic chip after the sample removal device has been inserted into the input channel.

6. The system as claimed in claim 2, further comprising a sample input device that receives a part of the sample removal device with the sample material located thereon.

7. The system as claimed in claim 6, wherein the sample input device comprises a receiving body or a receiving space configured to receive a part of the sample removal device with the sample material located thereon.

8. The system as claimed in claim 6, wherein the sample input region on the microfluidic chip comprises a recess configured to apply the sample input device with the part of the sample removal device and with the sample material located thereon.

9. The system as claimed in claim 6, wherein the sample input device comprises a hollow cylinder with an attachment configured for the microfluidic chip.

10. The system as claimed in claim 6, wherein the sample input device comprises a receiving body with a spiral-shaped receiving channel for a part of the sample removal device with the sample material located thereon.

11. The system as claimed in claim 6, wherein the sample input device comprises a receiving body with a receptacle configured for an end or a portion of the part of the sample removal device with the sample material located thereon.

12. The system as claimed in claim 11, wherein the receiving body comprises an input channel for the part of the sample removal device with the sample material located thereon.

13. The system as claimed in claim 10, wherein the receiving body has a seal which seals off the sample input region, on or in the microfluidic chip, from the environment.

14. A sample removal device for a system for introducing sample material, the system including a microfluidic chip and a sample input region disposed on or in the microfluidic chip and configured to introduce the sample material, the sample removal device comprising:
a body; and
a sealing element arranged on the body, the sealing element configured to seal off one or more of an attachment port and an input channel of the sample input region from the environment of the microfluidic chip after the sample removal device has been inserted into the input channel.

15. A method for introducing sample material, located on a sample removal device, into a sample input region, comprising:
arranging a part of the sample removal device in the sample input region of a microfluidic chip in order to introduce the sample material located on the sample removal device into the microfluidic chip, the sample input region disposed on or in the microfluidic chip.

16. The system as claimed in claim 2, wherein the sample removal device is configured as a biopsy needle.

17. The system as claimed in claim 7, wherein the part of the sample removal device received by the receiving body or the receiving space is flexible.
